(19) United States
(12) Patent Application Publication
(10) Pub. No.: US 2009/0058858 A1
(43) Pub. Date: Mar. 5, 2009

(54) ELECTRONIC APPARATUS HAVING GRAPH DISPLAY FUNCTION

(75) Inventor: Hironori YOSHIKAWA, Hamura-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 12/201,025

(22) Filed: Aug. 29, 2008

(30) Foreign Application Priority Data
Sep. 3, 2007 (JP) 2007-227234

(51) Int. Cl. G06T 11/20; G06F 15/02; G06F 3/00

(52) U.S. Cl. 345/440; 708/161

(57) ABSTRACT

An electronic apparatus having a graph display function comprises an expression memory configured to store an expression including expression elements, a parameter setting unit configured to set an expression element included in the expression stored in the expression memory as a coordinate parameter in accordance with operation made by a user, and a graph plotting unit configured to plot a graph of the expression based on the coordinate parameter set by the parameter setting unit.

### CROSS-REFERENCE TO RELATED APPLICATIONS

This application is based upon and claims the benefit of priority from prior Japanese Patent Application No. 2007-227234, filed Sep. 3, 2007, the entire contents of which are incorporated herein by reference.

### BACKGROUND OF THE INVENTION

1. Field of the Invention

The present invention relates to an electronic apparatus having a graph display function of plotting a graph of an input mathematical expression on a display unit.

2. Description of the Related Art

Conventionally, a small-sized electronic calculator called “graphing calculator” has been widely put to practical use. According to the graphing calculator, user selects a graph type (coordinate system such as orthogonal coordinate system or polar coordinate system) and inputs various mathematical expressions in accordance with a predetermined format given corresponding to the selected graph type. The graphing calculator plots and displays a graph of an input mathematical expression. The graphing calculator is used in a field of education, and such learning is made that user inputs various expressions and the graphs are plotted, then the user confirms the graphs.

As disclosed in Jpn. Pat. Appln. KOKAI Publication No. 2003-296285, use of the graphing calculator allows effective learning as below. That is, a student inputs an expression element including a variable “X” or “θ”, for example, to a corresponding field “□” in the predetermined format of “Y=□” (orthogonal coordinate system) or “r=□” polar coordinate system), then a graph corresponding to the input is plotted.

Although the graphing calculator can plot and display graphs of various input expressions, the notation of expressions to be input is limited to “Y −□” in the orthogonal coordinate system or limited to “r−□” in the polar coordinate system. In addition, the notation of corresponding variables to be input is also predetermined as “X” or “θ”.

Thus, for example, in order to plot a graph indicative of relationship between P and T in the equation of state “PV=nRT” in the orthogonal coordinate system, the user is required to perform a troublesome procedure of changing the form of the equation from “PV=nRT” to “Y=(nR/V)·X” by transforming “PV=nRT” to “P=nRT/V” and substituting Y for P and X for T. Besides, such setting of coordinates that elements of an expression, i.e., two or more variables, are gathered together and regarded as one parameter in graph display is not possible.

### BRIEF SUMMARY OF THE INVENTION

According to one embodiment of the present invention, an electronic apparatus having a graph display function comprises an expression memory configured to store an expression including expression elements, a parameter setting unit configured to set an expression element included in the expression stored in the expression memory as a coordinate parameter in accordance with operation made by a user and a graph plotting unit configured to plot a graph of the expression based on the coordinate parameter set by the parameter setting unit.

According to another embodiment of the present invention, a graph plotting method executed in an electronic apparatus having a graph display function, the graph plotting method comprises inputting an expression including expression elements, setting an expression element included in the expression as a coordinate parameter in accordance with operation made by a user and plotting a graph of the expression based on the set coordinate parameter.

According to another embodiment of the present invention, a calculator includes a key input unit, a display unit, a controller and a memory, the controller executes inputting an expression including expression elements using the key input unit, setting an expression element included in the expression as a coordinate parameter in accordance with operation made by a user, and plotting a graph of the expression based on the set coordinate parameter.

### BRIEF DESCRIPTION OF THE SEVERAL VIEWS OF THE DRAWING

The accompanying drawings, which are incorporated in and constitute a part of the specification, illustrate embodiments of the present invention and, together with the general description given above and the detailed description of the embodiments given below, serve to explain the principles of the present invention in which:

FIG. 1 is a block diagram showing an electronic circuit configuration of a graphing calculator according to an embodiment of an electronic apparatus having a graph display function;

FIG. 2 is a view showing character-coordinate relation information stored in a memory area;

FIG. 3 is a view showing formula-coordinate relation information stored in the memory area;

FIG. 4 is a flowchart illustrating entire operation of the graphing calculator in a graph mode;

FIG. 5 is a flowchart of an expression input process;

FIG. 6 is a flowchart of a coordinate system setting process;

FIG. 7 is a flowchart of a coordinate parameter setting process;

FIG. 8 is a flowchart illustrating a coordinate parameter automatic setting process;

FIG. 9 is a flowchart of a graph display process;

FIGS. 10A, 10B, 10C and 10D are views illustrating a first operation example;

FIGS. 11A, 11B, 11C and 11D are views illustrating a second operation example;

FIGS. 12A and 12B are views illustrating a third operation example;

FIGS. 13A, 13B and 13C are views illustrating a fourth operation example; arid FIGS. 14A, 14B and 14C are views illustrating a fifth operation example.

### DETAILED DESCRIPTION OF THE INVENTION

An embodiment of an electronic apparatus having a graph display function according to the present invention will now be described with reference to the accompanying drawings.

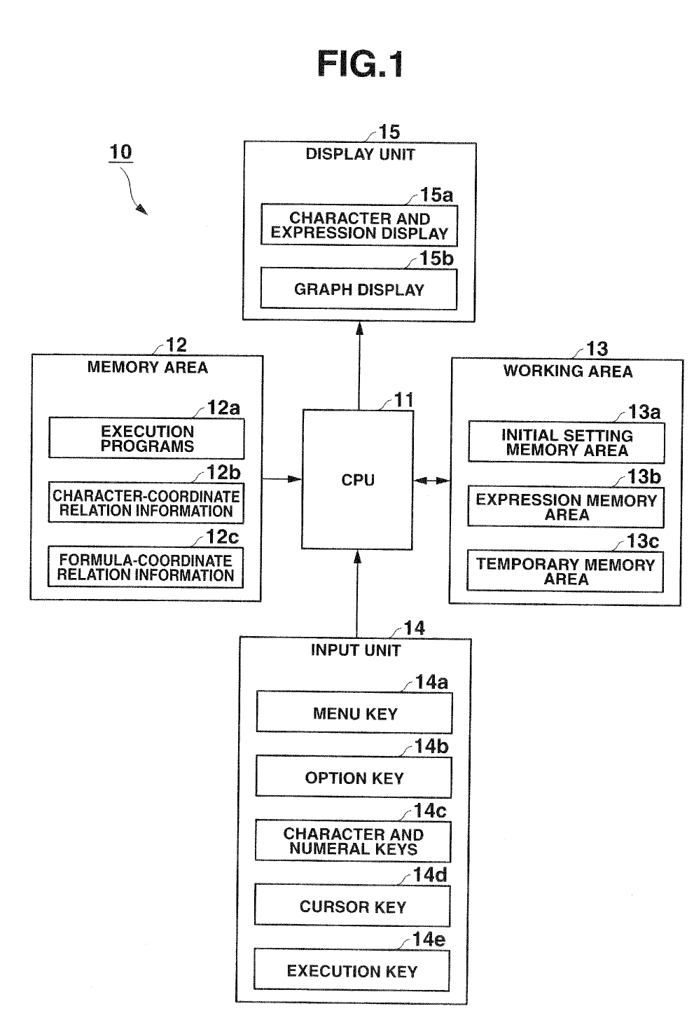

FIG. 1 is a block diagram showing an electronic circuit configuration of a graphing calculator according to an embodiment of the electronic apparatus having the graph display function of the present invention. The graphing calculator 10 according to the embodiment includes a control unit (CPU) 11 which contains a computer and others.

The control unit (CPU) 11 boots up a system program prestored in a memory area 12 such as a flash ROM in response to input data that is input from an input unit 14 and controls operations of respective circuit components by using a working area 13 such as a RAM.

The input unit 14, memory area (ROM) 12 and working area (RAM) 13 are connected to the controls unit 11. In addition, a display unit 15 is connected to the control unit 11. On the display unit 15, a character and expression display area 15a and a graph display area 15b are set as needed.

The memory area 12 prestores the system program for controlling overall processing of the electronic circuit of the graphing calculator 10. In addition, the memory area 12 stores various execution programs 12a, character-coordinate relation information 12b, and formula-coordinate relation information 12c. The execution programs 12a include programs for executing various operations. The character-coordinate relation information 12b stores characters and corresponding coordinate systems. The formula-coordinate relation information 12c stores various formulas such as a mathematical formula or a physical law in association with a coordinate system, a coordinate parameter and a plotting range.

The input unit 14 is provided with a key input unit including a menu key 14a, an option key 14b, character and numeral keys 14c, a cursor key 14d, and an execution (EXE) key 14e.

The menu key 14a is operated for selecting any mode from various operation modes of the graphing calculator 10, for example, “calculation mode” or “graph mode”.

The option key 14b is operated, in the case where any of the operation modes is being executed in the graphing calculator 10, to display a menu screen for prompting a user to select a function specific to the present operation mode. For example, when the option key 14b is operated during the execution of the “graph mode”, selectable functions including “graph type automatic setting”, “coordinate parameter automatic setting” and “formula call instruction” are displayed on list.

The character and numeral keys 14c include keys for inputting symbol, character or numeral (hereinafter, generically referred to as “expression element”). The user inputs desired expression by operating a combination of some of the character and numeral keys 14c. The cursor key 14d is operated for moving a cursor pointer P, which is displayed on the display screen of the display unit 15, in a desired direction. The execution key 14e is operated to finalize an immediately preceding operation and to advance the process to the next procedure, for example.

Form of the keys 14a to 14e, which are provided as the key input unit, are not limited to key form. The keys may be configured as displayed keys; namely, display screen of the display unit 15 may be a touch screen and indicators of the keys may be displayed on the touch screen. When any of the displayed keys is touched, operation information is input in accordance with the touch.

The working area (RAM) 13 includes an initial setting memory area 13a which prestores initial setting information set in accordance with operation made by the user. The initial setting memory area 13a prestores information such as data indicating a graph type, e.g., orthogonal coordinate data, and range data indicating a display range. In addition, the working area 13 includes an expression memory area 13b and a temporary memory area 13c. The expression memory area 13b stores an expression including a symbol, character, numeral, etc., which are input by the character and numeral keys 14c in the graph mode. The temporary memory area 13c temporarily stores various data used in operations.

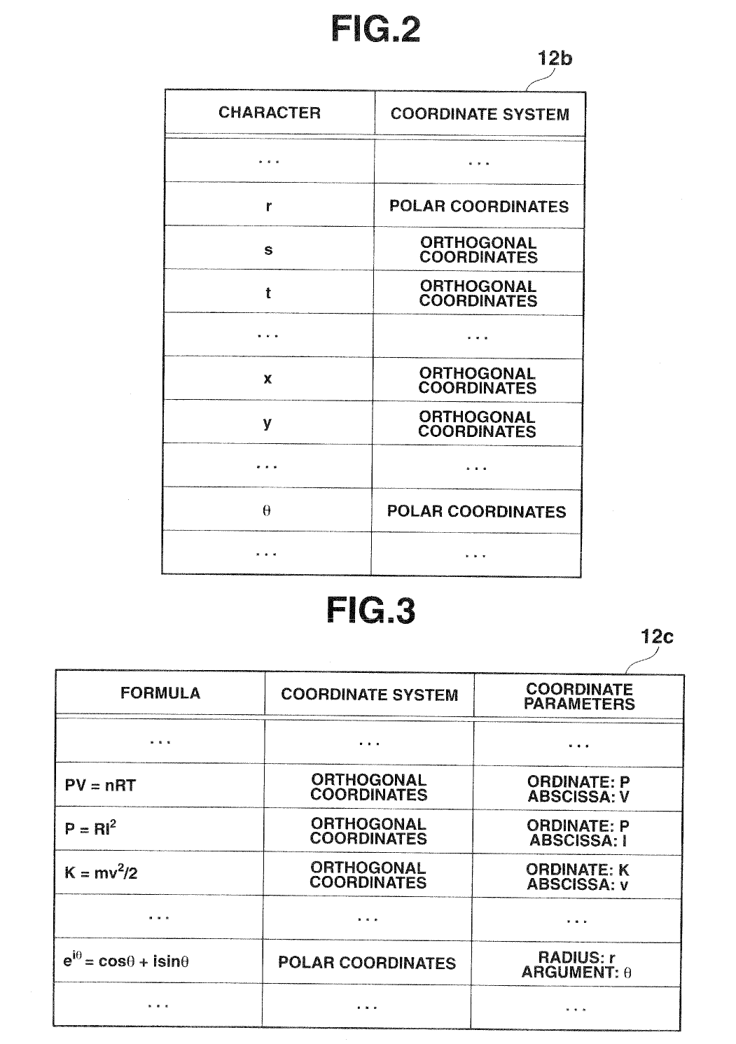

FIG. 2 is a view showing the content of the character-coordinate relation information 12b stored in the memory area 12. The character-coordinate relation information 12b provides relationship between a character to be used in an expression and a coordinate system to be set in general when the character is used. The polar coordinate system is related to r and θ, and the orthogonal coordinate system is associated with s, t, x and y.

FIG. 3 is a view showing the content of the formula-coordinate relation information 12c stored in the memory area 12. In the formula-coordinate relation information 12c, each of formulas such as PV=nRT, P−R1², . . . is associated with a graph type (data indicative of a coordinate system such as orthogonal coordinate system and polar coordinate system) which is set in general for displaying a graph of the formula, and coordinate parameters of ordinate and abscissa axes of the graph.

Next, the operation of the graphing calculator 10 having the above-described configuration is described.

Firstly, when the user turns on the power of the graphing calculator 10 and operates the menu key 14a, various selectable operation modes such as a calculation mode and a graph mode are displayed. When the user selects the graph mode by using the cursor key 14d, the graphing calculator 10 is set in the graph mode.

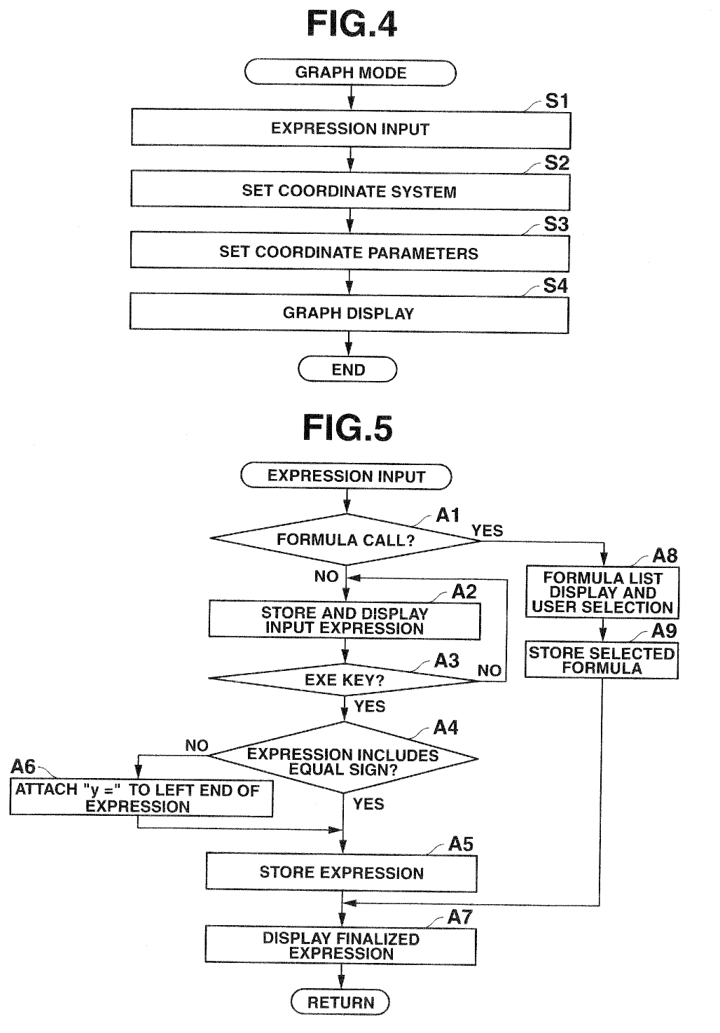

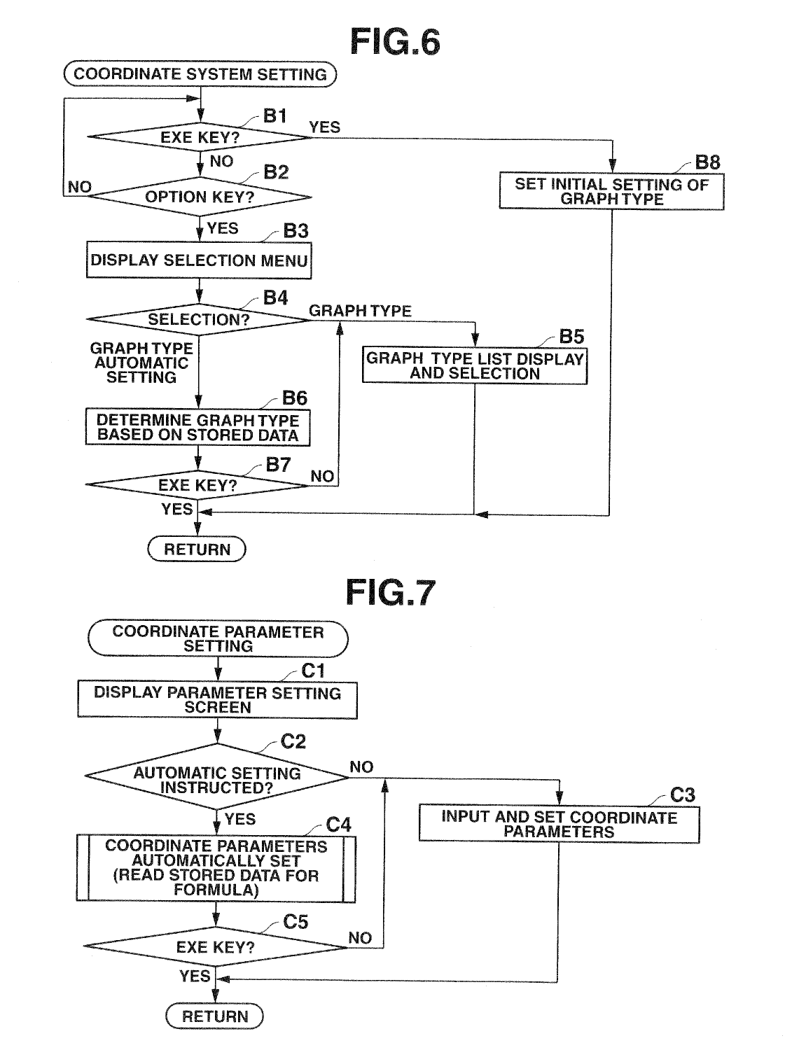

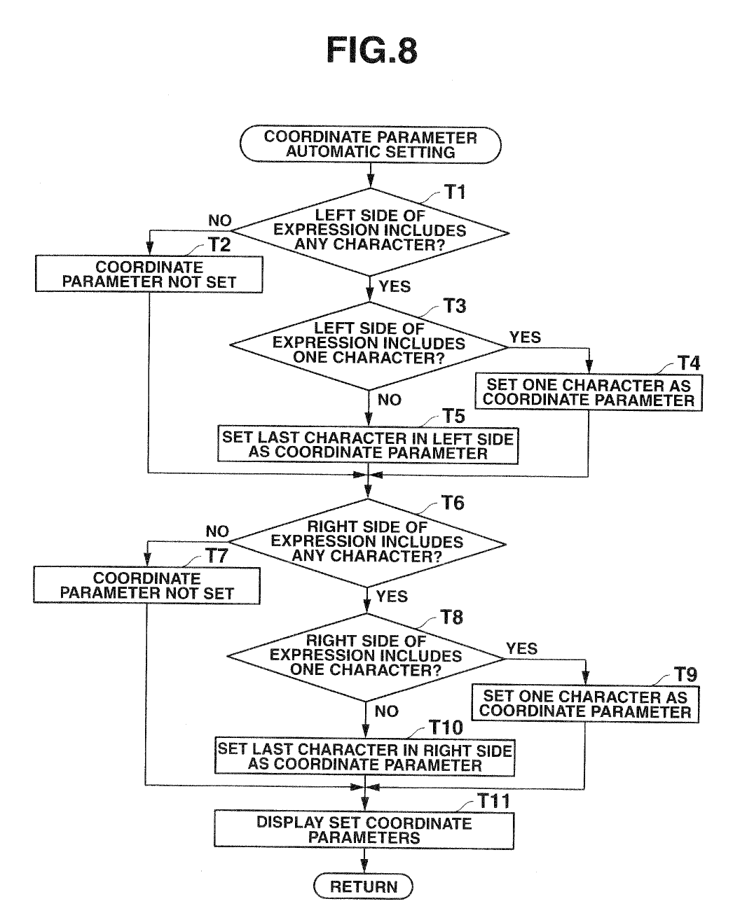

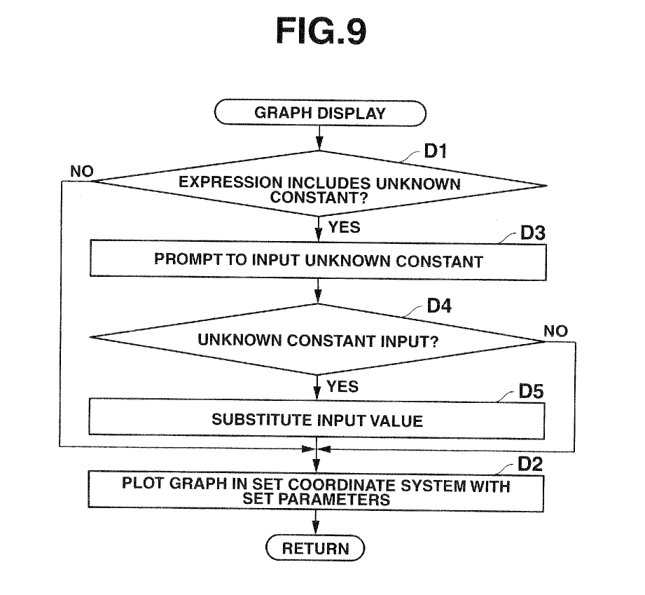

FIG. 4 is a flowchart illustrating entire operation of the graphing calculator 10 in the graph mode. As shown in FIG. 4, the process in the graph mode includes an expression input process (step S1), a coordinate system setting process (step S2), a coordinate parameter setting process (step S3) and a graph display process (step S4). The detail of the expression input process (step S1) is shown in FIG. 5. The detail of the coordinate system setting process (step S2) is shown in FIG. 6. The detail of the coordinate parameter setting process (step S3) is shown in FIGS. 7 and 8, and the detail of the graph display process (step S4) is shown in FIG. 9.

FIG. 5 is a flowchart of the expression input process. In the expression input process, it is determined whether or not formula call instruction is input (step A1). When the user operates the option key 14b, a list of selectable functions is displayed, and user can input formula call instruction by selecting an item of “formula call instruction”. However, when the user inputs a desired expression, it is determined that the formula call instruction is not input.

When the formula call instruction is not input and an expression is input (No in step A1), the input expression is stored in the temporary memory area 13c and displayed on the display unit 15 (step A2). A cursor pointer P is displayed at the end of the expression. A character and numeral input standby state is maintained until the execution (EXE) key 14e is operated (step A3). When the execution key 14e is operated (Yes in step A3), the input expression is finalized. Then, it is determined whether or not the input expression includes an equal sign (step A4). When the input expression includes an equal sign (Yes in step A4), the flow goes to step A5. On the other hand, when the input expression does not include an equal sign (No in step A4), “y=” is attached to the left end of the expression (step A6). Then, the expression is defined as the object of graph plotting and stored in the expression memory area 13b (step A5). Then, the expression is displayed on the display unit 15 without the cursor pointer P (step A7).

On the other hand, when the formula call instruction is input in step A1 (Yes in step A1), formulas are read out from the formula-coordinate relation information 12c (FIG. 3), a list of the read formulas is displayed (for example, as shown in FIG. 14A), and the user selects a desired one of the formulas (step A8). The selected formula is defined as the object of graph plotting and stored in the expression memory area 13b (step A9).

After the object of the graph plotting is defined as described above, the flow goes to the coordinate system setting process shown in FIG. 6.

FIG. 6 is a flowchart of the coordinate system setting process. In the coordinate system setting processing, firstly, it is determined whether or not the execution (EXE) key 14e or the option key 14b is operated (step B1 and B2).

When the execution key 14e is operated (Yes in step B1), a graph type stored in the initial setting memory area 13a is read out and set (step B8). The user may set in advance a graph type (coordinate system) by default. This default graph type is read and set as a coordinate system for graph plotting. The set coordinate system for graph plotting is stored in the temporary memory area 13c.

When the execution key 14e is not operated (No in step B1), it is determined whether or not the option key 14b is operated (step B2). When the option key is operated (Yes in step B2), a selection menu is displayed on the display unit 15 (step B3). On the selection menu screen, selectable functions specific to the graph mode are displayed. For example, on the display screen, items of “graph type” and “graph type automatic setting” are displayed prompting the user to select whether the graph type will be set by the user or set automatically.

When the user selects the item of “graph type” in step B4, a list of selectable coordinate systems is displayed and the user selects one of the coordinate systems (step B5). The selected coordinate system is set as the coordinate system for graph plotting. The coordinate system for graph plotting is stored in the temporary memory area 13c.

On the other hand, when the user selects the item of “graph type automatic setting” in step B4, a coordinate system is determined based on data stored in the memory area 12 (step B6). When the object of graph plotting defined in the expression input process (see FIG. 5) is an expression input by the user, all characters included in the input expression are read out from the expression memory area 13b. Coordinate systems corresponding respectively to the read characters are also read from the character-coordinate relation information 12b. Then, the coordinate system which is read out most is determined as the coordinate system for graph plotting. The determined coordinate system for graph plotting is stored in the temporary memory area 13c. In the case where there are a plurality of coordinate systems read most, the coordinate system corresponding to the character which is at the foremost part of the expression is preferentially determined. However, when the object of graph plotting is a formula selected in the expression input process, a coordinate system corresponding to the formula is read from the formula-coordinate relation information 12c. The read coordinate system is determined as the coordinate system for graph plotting. The determined coordinate system for graph plotting is stored in the temporary memory 13c.

Then, it is determined whether or not the execution key 14e is operated (step B7). When the execution key 14e is operated (Yes in step B7), the coordinate system determined in step B6 is settled. When the determined coordinate system is not a coordinate system which the user desires, the user does not operate the execution key 14e (No in step B7) and the graph type can be reconfigured (step B5).

After the coordinate system for graph plotting is determined, the flow goes to the coordinate parameter setting process shown in FIG. 7.

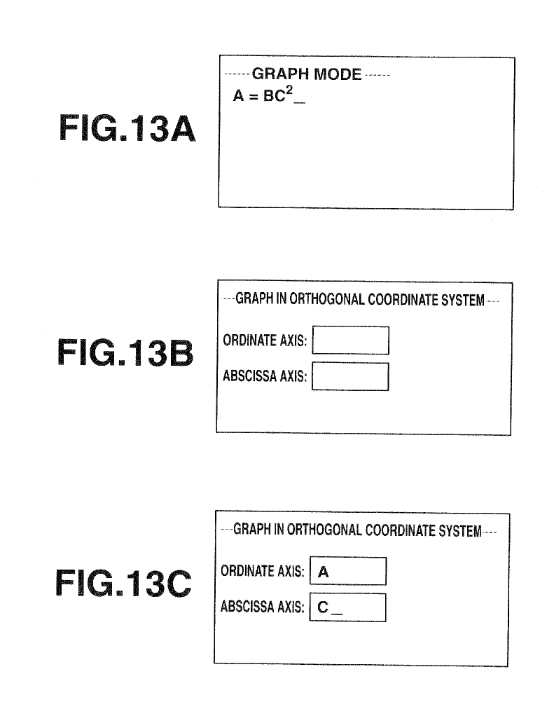

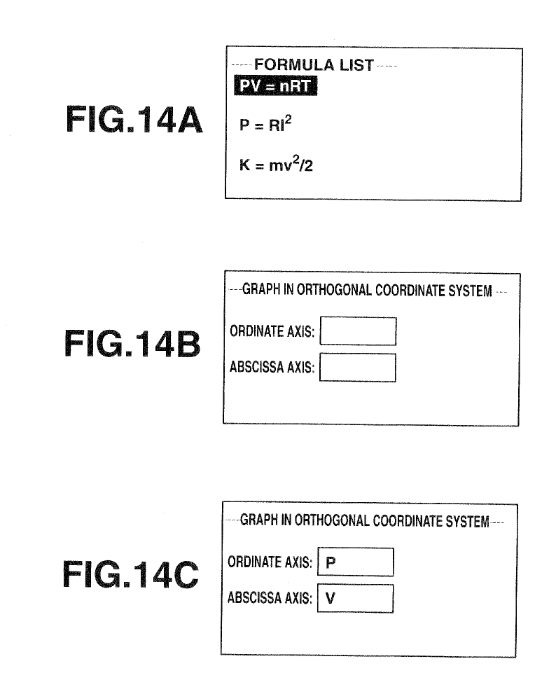

FIG. 7 is a flowchart of the coordinate parameter setting process. In the coordinate parameter setting process, a parameter setting screen corresponding to the coordinate system for graph plotting is displayed (step C1). The parameter setting screen includes fields for inputting parameters. For example, when the orthogonal coordinate system is determined as the coordinate system for graph plotting, the parameter setting screen includes two fields to input “ordinate axis” and “abscissa axis” (as shown in FIG. 13B, for example). Then, it is determined whether or not automatic setting of coordinate parameters is instructed (step C2). When the user operates the option key 14b, a list of functions is displayed. When the item of “coordinate parameter automatic setting” is selected, the automatic setting of coordinate parameters is instructed.

When the automatic setting instruction is not made (No in step C2), the user inputs characters in the fields by operating the character and numeral keys 14c and input characters are set as the coordinate parameters for graph plotting (step C3). The set coordinate parameters are stored in the temporary memory area 13c.

For example, in the case where “Y” is input to the field of “ordinate axis” and “X” is input to the field of “abscissa axis” in the orthogonal coordinate system, “Y” is used as the ordinate axis and “X” is used as the abscissa axis when plotting a graph.

On the other hand, when “coordinate parameter automatic setting” is selected in step C2 (Yes in step C2), coordinate parameters are automatically set (step C4). Coordinate parameter automatic setting process executed in step C4 is described in detail in FIG. 8 which will be explained later. It should be noted that in the case where the object of graph plotting is a selected formula, when “coordinate parameter automatic setting” is selected in step C2, coordinate parameters stored in association with the formula is read from the formula-coordinate relation information 12c (see FIG. 3) and the read coordinate parameters are automatically set as the coordinate parameters for graph plotting in step C4. When the user operates the execution key 14e (Yes in step C5), the coordinate parameters set in step C4 are settled and stored in the temporary memory 13c. However, when the user desires to change the set coordinate parameters and does not operates the execution key 14e (No in step C5), the coordinate parameters can be reconfigured by operation made by the user (step C3).

After the coordinate parameters are set, the flow advances to the graph display process shown in FIG. 9.

FIG. 9 is a flowchart of the graph display process. In the graph display process, firstly, it is determined whether or not the object of the graph plotting includes a character other than the set coordinate parameters (hereinafter referred to as “unknown constant”) (step D1)

When the object of the graph plotting does not include any unknown constant (No in step D1), the flow goes to step D2.

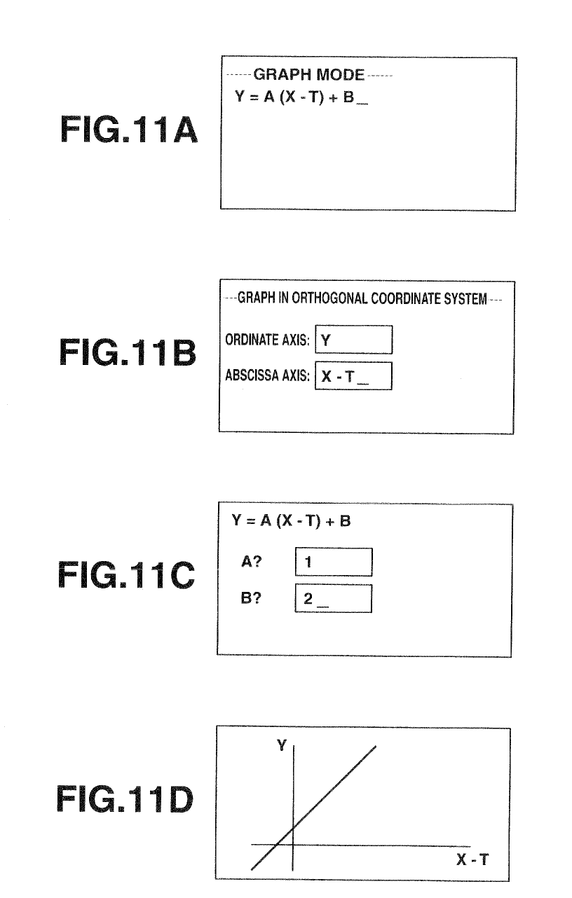

On the other hand, when it is determined that the object of the graph plotting includes an unknown constant (Yes in step D1), a screen requiring the user to input a numerical value corresponding to the unknown constant is displayed (for example, shown in FIG. 11C). When the user inputs the numerical value (Yes in step D4), the input value is substituted for the unknown constant (step D5). When no numerical value is input (No in step D4), the unknown constant is treated as unknown constant as it is in the subsequent operation.

Then, a graph of the object of graph plotting is plotted and displayed (step D2). The graph is plotted in the coordinate system for graph plotting determined in the coordinate system setting process shown in FIG. 6, and axes of the graph are indicated by the coordinate parameters set in the coordinate parameter setting process shown in FIG. 7.

The range of graph plotting corresponds to setting of plotting range data (range data), which is stored in advance in the initial setting memory area 13a.

Hereinafter, operation examples according to the graph mode will he described.

### FIRST OPERATION EXAMPLE

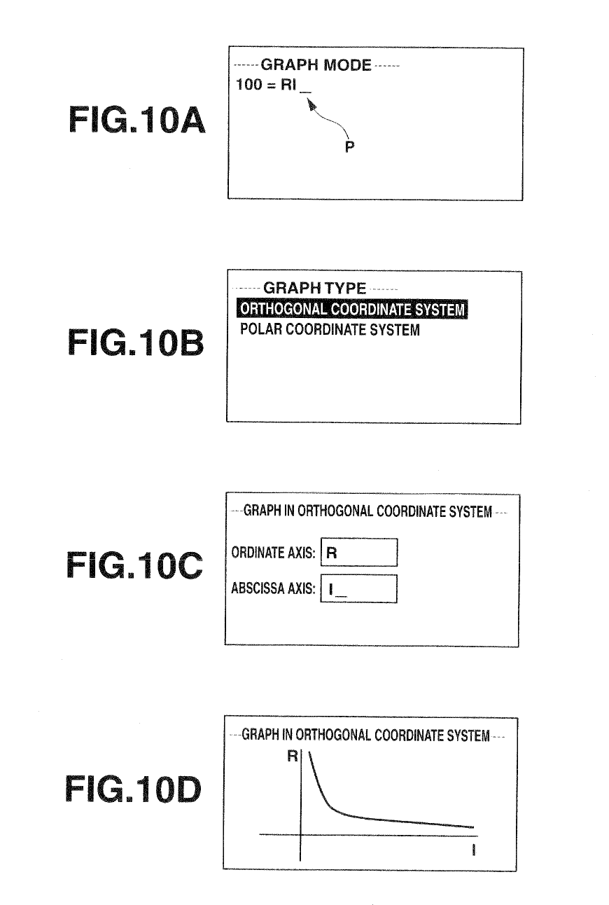

FIGS. 10A, 10B, 10C and 10D illustrate a first operation example of the graphing calculator 10. This example relates to a case in which the user inputs a desired expression, and the user also sets a graph type (coordinate system) and coordinate parameters.

In the expression input process (see FIG. 5) of the graph mode, when the formula call instruction is not input and the user inputs “1”, “0”, “0”, “=”, “R” and “I” using the character and numeral keys 14c (No in step A1), the input expression “100=RI” is stored in the temporary memory area 13c and displayed on the display unit 15, as shown in FIG. 10A (step A2). A cursor pointer P is displayed at the end of the expression.

When the execution key 14e is operated by the user (Yes in step A3), it is determined whether or not the input expression includes an equal sign (step A4). In this example, the input mathematical expression includes the equal sign (Yes in step A4), and the input expression “100=RI” is defined as the object of graph plotting and stored in the expression memory area 13b (step A5). The expression defined as the object of graph plotting is displayed on the display unit 15 (step A7).

In the coordinate system setting process (see FIG. 6), the graphing calculator 10 waits until the execution (EXE) key 14e or the option key 14b is operated (steps B1 and B2). When the option key 14b is operated (Yes in step B2), the selection menu is displayed (step B3). In this example, the selection menu includes a list of the items of “graph type” and “graph type automatic setting”. When the user selects “graph type” (step B4), two items indicating the coordinate systems of “orthogonal coordinate system” and “polar coordinate system” are displayed as graph types on list as shown in FIG. 10B and the user selects a coordinate system (step B5). The selected coordinate system is set as the coordinate system for graph plotting. In the present operation example, the user selects “orthogonal coordinate system” and the orthogonal coordinate system is set as the graph type (coordinate system) for graph plotting. The graph type information is stored in the temporary memory area 13c, and the coordinate system setting process is terminated.

In the coordinate parameter setting process (see FIG. 7), a parameter setting screen corresponding to the selected orthogonal coordinate system is displayed (step C1). The parameter setting screen includes two fields to input “ordinate axis” and “abscissa axis”. When it is determined that an automatic setting instruction is not input (No in step C2), the user inputs “R” in the field of “ordinate axis” and “I” in the field of “abscissa axis” by using the character and numeral keys 14c and the cursor key 14d, and the input “R” and “I” are displayed in the fields of “ordinate axis” and “abscissa axis” on the parameter setting screen as shown in FIG. 10C. The input characters are stored in the temporary memory area 13c and set as the coordinate parameters for graph plotting (step C3). After the coordinate parameters are set, the flow advances to the graph display process.

In the graph display process (see FIG. 9), it is determined whether or not the object of the graph plotting includes an unknown constant (step D1). In this operation example, the expression “100=RI” includes no unknown constant (No in step D1). Then, expression data is read from the expression memory area 13b, and coordinate system data and coordinate parameters are read from the temporary memory area 13c; thereby, a graph of the expression “100=RI” is plotted and displayed in the orthogonal coordinate system in which the ordinate axis is indicated by “PR” and the abscissa axis is indicated by “I” as shown in FIG. 10D (step D2).

The first operation example demonstrates a case in which simply the user inputs an express-on, and sets a graph type and coordinate parameters without transforming the expression or substituting characters. In such a case, the graphing calculator 10 can plot a graph corresponding to the input expression.

### SECOND OPERATION EXAMPLE

FIGS. 11A, 11B, 11C and 11D illustrate a second operation example. The second operation example relates to a case in which an expression includes an unknown constant.

In the expression input process (see FIG. 5) of the graph mode, when the formula call instruction is not input and the user inputs “Y”, “=” , “A”, “(”, “X”, “−”, “T”, “)”, “+” and “B” using the character and numeral keys 14c (No in step A1), the input expression “Y=A(X−T)+B” is displayed as shown in FIG. 11A (step A2). When the user operates the execution key 14e (Yes in step A3), it is determined that the input expression includes an equal sign (Yes in step A4). The input expression is defined as the object of graph plotting and stored in the expression memory area 13b (step A5). Then, the expression is displayed on the display unit (step A7).

In the coordinate system setting process (see FIG. 6), when the user operates the execution key 14e (Yes in step B1), initial setting of a graph type which is stored in the initial setting memory area 13a is read and set (step B8). In the present example, the orthogonal coordinate system is stored by default and the orthogonal coordinate system is defined as the graph type for graph plotting. Then the flow goes to the parameter setting process.

In the coordinate parameter setting process (see FIG. 7), a parameter setting screen corresponding to the orthogonal coordinate system is displayed (step C1). The parameter setting screen includes fields “ordinate axis” and “abscissa axis” to which the user inputs coordinate parameters. When automatic setting of coordinate parameters is not instructed (No in step C2), the user inputs “Y” in the field of “ordinate axis” and “X”, “−” and “T” in the field of “abscissa axis” for example, and the input parameters “Y” and “X−T” are displayed in the fields of “ordinate axis” and “abscissa axis” as shown in FIG. 11B (step C3). The input coordinate parameters are stored in the temporary memory area 13c and set as coordinate parameters for graph plotting. Then, the flow advances to the graph display process.

In the graph display process (see FIG. 9), it is determined whether or not the object of the graph plotting includes an unknown constant other than the set coordinate parameters (step D1). In this operation example, the expression “Y=A(X−T)+B” includes unknown constants A and B (Yes in step D1). Therefore, a screen requiring the user to input numerical values for the unknown constants A and B is displayed as shown in FIG. 11C (step D3). When the user inputs “I” in the filed of “A” and “2” in the field of “B” (Yes in step D4), 1 is substituted for the unknown constant “A”, 2 is substituted for the unknown constant “B” in the expression “Y=A(X−T)+B”, and the input numerals are settled (step D5).

The expression data is read from the expression memory area 13b, and coordinate system data and coordinate parameters are read from the temporary memory area 13c. Then, a graph of the expression “Y=A(X−T)+B” is plotted and displayed (step D2). As shown in FIG. 11D, the graph is plotted in the orthogonal coordinate system in which the ordinate axis is indicated by “Y” and the abscissa axis is denoted by “X−T”, given that A=1 and B=2.

### THIRD OPERATION EXAMPLE

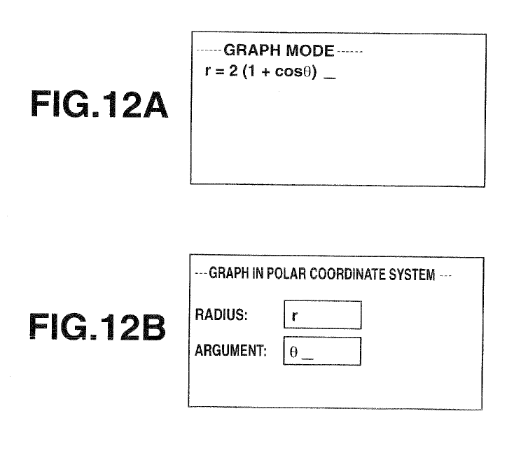

FIGS. 12A and 12B illustrate a third operation example. The third operation example relates to a case in which a graph type is automatically set.

In the expression input process (see FIG. 5) of the graph mode, when the formula call instruction is not input and the user: inputs “r”, “=”, “2”, “(”, “1”, “+”, “cos”, “θ” and “)” using the character and numeral keys 14c (No in step A1), the expression “r=2(1+cosθ)” is stored in the temporary memory 13c and displayed as shown in FIG. 12A (step A2). When the user operates the execution key 14e (Yes in step A3), it is determined that the input expression includes an equal sign (Yes in step A4). Then, the input expression is defined as the object of graph plotting and stored in the expression memory area 13b (step A5). The expression defined as the object of graph plotting is displayed on the display unit 15 (step A7). Then, the flow goes to the coordinate system setting process.

In the coordinate system setting process (see FIG. 6), when the user operates the option key 14b (Yes in step B2), a selection menu including the items “graph type” and “graph type automatic setting” is displayed (step B3). When the user selects “graph type automatic setting” in step B4, the coordinate system for graph plotting is determined on the basis of data stored in the memory area 12 (step B6). In this case, all characters included in the expression of the object of graph plotting are read out from the expression memory area 13b, coordinate systems corresponding respectively to the read characters are also read from the character-coordinate relation information 12b, and a coordinate system which is read most is determined as the coordinate system for graph display.

In this operation example, the input expression “r=2(1+cosθ) ” includes the characters “r” and “θ”. Therefore, data indicative of the polar coordinate system is obtained in correspondence with the characters from the character-coordinate relation information 12b (FIG. 2), and the polar coordinate system is determined as the coordinate system for graph plotting. When the execution key 14e is operated (Yes in step B7), the setting of the coordinate system is terminated. The flow advances to the coordinate parameter setting process.

In the coordinate parameter setting process (see FIG. 7), a parameter setting screen corresponding to the polar coordinate system is displayed (step C1). The parameter setting screen includes fields to input “radius” and “argument”. When it is determined that an automatic setting instruction is not input (No in step C2) and the user inputs “r” in the field of “radius” and “θ” in the field of “argument” as shown in FIG. 12B, the input characters are set as the coordinate parameters for graph plotting and also the input parameters “r” and “θ” are displayed in the fields of “radius” and “argument” (step C3). The subsequent graph display process is similar to that in the above described operation examples, so the description thereof is omitted.

The third operation example demonstrates that the user inputs an arbitrary expression and configures a graph type (coordinate system) to be automatically set, whereby the coordinate system can automatically be set on the basis of characters which the expression of the object of graph plotting stored in the expression memory area 13b includes.

### FOURTH OPERATION EXAMPLE

FIGS. 13A, 13B and 13C illustrate a fourth operation example. In the fourth operation example, coordinate parameters are automatically set.

In the expression input process (see FIG. 5), when the formula call instruction is not input and the user inputs “A”, “=”, “B”, “C” and “x2” using the character and numeral keys 14c (No in step A1), the input expression “A=BC²”, is stored in the temporary memory area 13c and displayed as shown in FIG. 13A (step A2). The input “x2” indicates a function of squaring a numerical value or character that is input immediately before, and thus the square of “C” is displayed. A cursor pointer P is displayed at the end of the expression, and the input standby state is kept.

When the user operates the execution key 14e (Yes in step A3), it is determined that the input expression includes an equal sign (Yes in step A4). The input expression is defined as the object of graph plotting and stored in the expression memory area 13b (step A5). The expression is displayed on the display unit 15 (step A7). Then, the expression input process is completed.

In the coordinate system setting process (see FIG. 6)), when the user operates the execution key 14e (Yes in step B1), initial setting of a graph type which is stored in the initial setting memory area 13a is read and set (step B8). In the present example, the orthogonal coordinate system is stored by default and the orthogonal coordinate system is read and defined as the graph type for graph plotting. Then, the flow goes to the coordinate parameter setting process.

In the coordinate parameter setting process (see FIG. 7), a parameter setting screen is displayed as shown in FIG. 13B (step C1). The parameter setting screen includes fields “ordinate axis” and “abscissa axis” to which the user inputs coordinate parameters.

To automatically set coordinate parameters, the user is required to operate the option key 14b on the parameter setting screen and to select the item of “coordinate parameter automatic setting”. When the user operates the option key 14b and “coordinate parameter automatic setting” is selected (Yes in step C2), the coordinate parameter automatic setting process shown in FIG. 8 is executed (step C4).

FIG. 8 shows a flowchart illustrating the coordinate parameter automatic setting process of the graphing calculator 10.

Firstly, it is determined whether or not the left side of the expression which is the object of graph plotting and stored in the expression memory area 13b includes any character (step T1). When it is determined that the left side of the expression does not include any character (No in step T1), a coordinate parameter is not set (step T2) and the flow advances to step T6. On the other hand, when it is determined that the left side of the expression includes any character (Yes in step T1), then it is determined whether or not the left side includes only one character (step T3). When it is determined that the left side includes only one character (Yes in step T3), this one character is set as a coordinate parameter for graph plotting (step T4), and the flow advances to step T6. When it is determined that the left side of the expression includes a plurality of characters (No in step T3), the last character in the left side of the expression is set as a coordinate parameter for graph plotting (step T5), and the flow advances to step T6.

A similar processing to the processing executed with respect to the left side of the expression in steps T1 to T5 is executed with respect to the right side of the expression in steps T6 to T11. The coordinate parameters set through the processing of steps T1 to T10 are displayed (step T11). The set coordinate parameters are stored in the temporary memory area 13c and the coordinate parameter automatic setting process is terminated.

In the present operation example, since the left side of the expression stored in the expression memory area 13b is “A”, it is determined that the left side includes a character (Yes in steps T1 and T3). Accordingly, “A” is set as a coordinate parameter for graph plotting. Similarly, since the right side of the expression stored in the expression memory area 13b is “BC²”, it is determined that the right side includes more than one character (Yes in step T6 and No in step T8). Therefore, the last character in the right side, i.e., “C” is set as a coordinate parameter for graph plotting (step T10). As shown in FIG. 13C, the set coordinate parameters for graph plotting are displayed on the parameter setting screen (step T11).

To settle the coordinate parameters for graph plotting which are automatically set as described above, the user operates the execution key 14e (Yes in step C5).

The graph display process is similar to that in the above described operation examples, so a description thereof is omitted.

As described above, the fourth operation example demonstrates that coordinate parameters can be automatically set. That is, when automatically setting of coordinate parameters for graph plotting corresponding to the set coordinate system (graph type) is configured, the coordinate parameters for graph plotting are automatically set based on the numbers and positions of characters included in the left side and right side of the expression which is the object of graph plotting and stored in the expression memory area 13b.

### FIFTH OPERATION EXAMPLE

FIGS. 14A, 14B and 14C illustrate a fifth operation example. In the fifth operation example, a graph of a formula that is stored in the memory area 12 is displayed.

In the expression input process (FIG. 5), in the case where a list of selectable functions is displayed in response to operation of the option key 14b made by the user, when the user selects the item of “formula call instruction”, instruction of “formula call” can be made (Yes in step A1). Then, formulas are read out from the formula-coordinate relation information 12c (see FIG. 3), a list of the read formulas is displayed as shown in FIG. 14A, and the user selects a desired one of the formulas (step A8). For example, the user selects the equation of state “PV=nRT”. The selected formula is stored in the expression memory area 13b as the object of graph plotting (step A9), and the formula is displayed (step A7).

Subsequently, the coordinate system setting process (see FIG. 6) is initiated. When the option key 14b is operated (No in step B1 and Yes in step B2), the selection menu is displayed (step B3). In this example, the selection menu includes a list of the items of “graph type” and “graph type automatic setting”. When the user selects “graph type automatic setting” in step B4, the orthogonal coordinate system which corresponds to the formula “PV=nRT” is read from the formula-coordinate relation information 12c (see FIG. 3) and determined as the coordinate system (graph type) for graph plotting (step B6). The display unit 15 comes to display a screen shown in FIG. 14B. The screen indicates that the determined coordinate system is the orthogonal coordinate system. In addition, the screen may include fields to input coordinate parameters. When the user operates the execution key 14e (Yes in step B7), the coordinate system obtained in step B6 is settled.

In the coordinate parameter setting process (see FIG. 7), a parameter setting screen corresponding to the orthogonal coordinate system is displayed (step C1) as shown in FIG. 14B. The parameter setting screen includes the fields of “ordinate axis” and “abscissa axis” to which the user inputs coordinate parameters. When the user operates the option key 14b and “coordinate parameter automatic setting” is selected (Yes in step C2), the coordinate parameters for graph plotting are automatically set (step C4). That is, coordinate parameters “P” and “V” stored in association with the formula of “PV=nRT” are read from the formula-coordinate relation Information 12c and displayed as shown in FIG. 14C. In the present operation example, “P” is set for the ordinate axis, and “V” is set for the abscissa axis. When the user operates the execution key 14e (Yes in step C5), the coordinate parameters are settled and stored in the temporary memory 13c. Then the flow goes to the graph display process. In the graph display process (FIG. 9), the graph of the selected formula is displayed. The graph display process is similar to that in the above described operation examples, so the description thereof is omitted.

As described above, the fifth operation example demonstrates that, in the case where the user calls a list of formulas and selects an arbitrary formula, the user can configure a coordinate system or coordinate parameters corresponding to the selected formula to be automatically set. In response to operation made by the user, a coordinate system and coordinate parameters corresponding to the selected formula are automatically set, and a graph of the selected formula is displayed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic apparatus having a graph display function comprising:
an expression memory configured to store an expression including expression elements;
a parameter setting unit configured to set an expression element included in the expression stored in the expression memory as a coordinate parameter in accordance with operation made by a user; and
a graph plotting unit configured to plot a graph of the expression based on the coordinate parameter set by the parameter setting unit.

2. The electronic apparatus according to claim 1, further comprising:
a character display unit configured to display a character included in the expression, which is other than the expression element set as the coordinate parameter; and
a numerical value setting unit configured to set a numerical value corresponding to the character displayed by the character display unit in accordance with operation made by the user,
wherein the graph plotting unit plots the graph of the expression substituting the numerical value set by the numerical value setting unit for the character other than the expression element set as the coordinate parameter.

3. The electronic apparatus according to claim 1, further comprising:
a coordinate system memory configured to store characters in association with corresponding coordinate systems; and
a coordinate system setting unit configured to detect a coordinate system corresponding to a character included in the expression from the coordinate system memory, and to set the detected coordinate system as a coordinate system of the expression,
wherein the parameter setting unit sets at least one expression element included in the expression as at least one coordinate parameter of the coordinate system set by the coordinate system setting unit in accordance with operation made by the user.

4. The electronic apparatus according to claim 3, wherein the parameter setting unit comprising:
a first coordinate parameter setting unit configured to detect, when right or left side of the expression includes one character, a coordinate system corresponding to the one character from the coordinate system memory, and to set the one character as a coordinate parameter in the coordinate system detected from the coordinate system memory; and
a second coordinate parameter setting unit configured to detect, when the right or left side of the expression includes more than one characters, a coordinate system corresponding to a character which is at end of the right or left side, and to set the character which is at end of the right or left side as a coordinate parameter in the coordinate system detected from the coordinate system memory.

5. The electronic apparatus according to claim 1, wherein, when the expression does not include a equal sign, the parameter setting unit operates assuming that the expression includes “y=” at a left side of the expression.

6. The electronic apparatus according to claim 1, further comprising:
a formula memory configured to store at least one formula in association with a corresponding coordinate system and a coordinate parameter;
a formula selection unit configured to select a formula stored in the formula memory;
wherein the parameter setting unit sets a coordinate parameter associated with the formula selected by the formula selection unit based on a coordinate parameter which the formula memory stores in association with the formula.

7. A graph plotting method executed in an electronic apparatus having a graph display function, the graph plotting method comprising:
inputting an expression including expression elements;
setting an expression element included in the expression as a coordinate parameter in accordance with operation made by a user; and
plotting a graph of the expression based on the set coordinate parameter.

8. The graph plotting method according to claim 7, further comprising:
displaying a character included in the expression, which is other than the expression element set as the coordinate parameter; and
setting a numerical value corresponding to the displayed character in accordance with operation made by the user, and
wherein the graph of the expression is plotted substituting the set numerical value for the character other than the expression element set as the coordinate parameter.

9. The graph plotting method according to claim 7,
wherein the electronic apparatus comprises a coordinate system memory configured to store characters in association with corresponding coordinate systems,
the graph plotting method further comprising detecting a coordinate system corresponding to a character included in the expression from the coordinate system memory and setting the detected coordinate system as a coordinate system of the expression, and
wherein at least one expression element included in the expression is set as at least one coordinate parameter of the set coordinate system in accordance with operation made by the user.

10. The graph plotting method according to claim 9, setting an expression element included in the expression as a coordinate parameter comprising:
detecting, when right or left side of the expression includes one character, a coordinate system corresponding to the one character from the coordinate system memory, and setting the one character as a coordinate parameter in the coordinate system detected from the coordinate system memory; and
detecting, when the right or left side of the expression includes more than one characters, a coordinate system corresponding to a character which is at end of the right or left side, and setting the character which is at end of the right or left side as a coordinate parameter in the coordinate system detected from the coordinate system memory.

11. The graph plotting method according to claim 7, wherein, when the expression does not include an equal sign, it is assumed that the expression includes “y=” at a left side of the expression.

12. The graph plotting method according to claim 7,
wherein the electronic apparatus comprises a formula memory configured to store at least one formula in association with a corresponding coordinate system and a coordinate parameter,
the graph plotting method further comprising selecting a formula stored in the formula memory, and
wherein a coordinate parameter associated with the selected formula is set based on a coordinate parameter which the formula memory stores in association with the formula.

13. A calculator including a key input unit, a display unit, a controller and a memory, the controller executing:
inputting an expression including expression elements using the key input unit;
setting an expression element included in the expression as a coordinate parameter in accordance with operation made by a user; and
plotting a graph of the expression based on the set coordinate parameter.

14. The calculator according to claim 13, the controller further executing:
displaying a character included in the expression, which is other than the expression element set as the coordinate parameter; and
setting a numerical value corresponding to the displayed character in accordance with operation made by the user, and
wherein the graph of the expression is plotted substituting the set numerical value for the character other than the expression element set as the coordinate parameter.

15. The calculator according to claim 13, further comprising a coordinate system memory configured to store characters in association with corresponding coordinate systems,
the controller further executing detecting a coordinate system corresponding to a character included in the expression from the coordinate system memory, and setting the detected coordinate system as a coordinate system of the expression, and
wherein at least one expression element included in the expression is set as at least one coordinate parameter of the set coordinate system in accordance with operation made by the user.

16. The calculator according to claim 15,
wherein setting an expression element included in the expression as a coordinate parameter comprises:
detecting, when right or left side of the expression includes one character, a coordinate system corresponding to the one character from the coordinate system memory, and setting the one character as a coordinate parameter in the coordinate system detected from the coordinate system memory; and
detecting, when the right or left side of the expression includes more than one characters, a coordinate system corresponding to a character which is at end of the right or left side, and setting the character which is at end of the right or left side as a coordinate parameter in the coordinate system detected from the coordinate system memory.

17. The calculator according to claim 13, wherein, when the expression does not include an equal sign, it is assumed that the expression includes “y=” at a left side of the expression.

18. The calculator according to claim 13, further comprising a formula memory configured to store at least one formula in association with a corresponding coordinate system and a coordinate parameter,
the controller further executing selecting a formula stored in the formula memory, and
wherein a coordinate parameter associated with the selected formula is set based on a coordinate parameter which the formula memory stores in association with the formula.
